(19) United States
(12) Patent Application Publication
(10) Pub. No.: US 2007/0186278 A1
(43) Pub. Date: Aug. 9, 2007

(54) Print processing system and print processing apparatus

(76) Inventors: Yasuhiro Fujii, Fujisawa (JP); Ryu Ebisawa, Yokohama (JP); Ken Kobayashi, Machida (JP); Tetsuo Takemoto, Machida (JP); Takashi Mizuno, Urayasu (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/429,141

(22) Filed: May 8, 2006

(30) Foreign Application Priority Data
Feb. 6, 2006 (JP) 2006-027854

(51) Int. Cl. H04L 9/32; G06K 9/00; G06F 17/30; G06F 15/16; G06F 7/04; G06F 7/58; G06K 19/00; G06F 17/00; G06F 9/00

(52) U.S. Cl. 726/5; 726/6; 726/7; 726/15

(57) ABSTRACT

In a thin client system, a PC authentication device which authenticates a client is set in an office of the client. Data existing in a server is printed by using a printer provided in the vicinity of a client PC according to the following steps. (1) The PC authentication device performs authentication with the client PC and acquires an identifier IDa of the client PC. (2) The PC authentication device notifies the server of the identifier IDa of the client PC and an identifier IDb of the PC authentication device. (3) The server registers the printer provided in the office where the PC authentication device having the identifier IDb is set as a printer which can be used by the client PC having the identifier Ida. According to the above-described flow, when the client PC is coupled with the server, the printer can be used.

### INCORPORATION BY REFERENCE

This application claims priority based on a Japanese patent application, No. 2006-027854 filed on Feb. 6, 2006, the entire contents of which are incorporated herein by reference.

### BACKGROUND

The present invention relates to a server thin client system, and more particularly to a print processing system which prints data in a server by using a printer provided in the vicinity of a client computer utilized by a user.

In tandem with the penetration of high-performance computers, installation of application software or an operation/management cost required for version upgrade is becoming a real and substantive problem. Thus, there has emerged a concept of a thin client system which reduces an operation/management cost. In this concept, an expensive personal computer having sophisticated functions is not used for a client computer (which will be referred to as a client PC hereinafter) such as a notebook PC or a desktop PC utilized by a general user, but a client PC (which is called a thin client) having minimum functions such as display or input is arranged as a client PC to manage resources such as application software by a server. A user manipulates resources such as application software or files in a server through an output device such as a display of a client PC or an input device such as a keyboard or a mouse.

Since resources such as application software or files manipulated by a user are stored in the server, data cannot be transferred to the client PC unless an operation of transfer is explicitly operated. Therefore, in a regular print operation, data cannot be printed unless a printer which can be directly accessed from the serer and provided in the network surrounded by a firewall is used. However, it is not practical if a user who accesses the server cannot perform printing by a printer provided in the vicinity of the currently operated client PC rather than a printer provided in the vicinity of the server.

As one of advantages of the thin client system, a notebook PC can be used as a client PC to operate resources in the server from an office distanced from the server, e.g., a business trip destination. Therefore, in order to practically realize print processing in the thin client system, a technical requirement is enabling remote printing of data in the server by using a printer near a user which is provided in a different network which cannot be directly accessed from the server.

There have been known some conventional techniques for printing data in a server at a remote site. For example, JP-A-2005-129007 discloses a technique by which a server side automatically selects an appropriate printer to transmit print data when a user specifies an office where a printer which should be used for printing exists.

### SUMMARY OF THE INVENTION

In the above-described conventional technique, since the server cannot recognize an office in which the client PC currently exists, a user must specify an office where a printer which should be used for printing by the user. If a wrong office is specified, there occurs a security problem that data is erroneously transmitted to a printer in the wrong office, resulting in leak of information.

Furthermore, an extra operation of specifying an office is performed, and hence there is another problem that an interface becomes different from that used in regular print processing. It is preferable to enable printing of data in regular print processing using a printer existing in the vicinity of a client PC without regard of a user.

In the present invention, there is provided a thin client system in which a server can recognize an office in which a client PC currently exists and a printer existing in this office can be used for printing.

In the system provided by the present invention, a server storing application software or files therein and a client PC operated by a user as well as a PC authentication device are set in each office. The PC authentication device is provided with a function of performing device authentication with the client PC. Additionally, the client PC is provided with not only a communicating function of establishing a communication path between itself and the server but also a function of performing device authentication with the PC authentication device.

Further, the server recognizes a printer set in each office, and can transmit a print job to a desired printer through a communication path. However, in a regular state, the client PC is disabled to use any printer.

Each device operates in the following order.

(1) The client PC performs device authentication with the PC authentication device. The PC authentication device establishes a communication path between itself and the client PC based on device authentication to acquire an identifier IDa of the client PC.

(2) The PC authentication device notifies the server of the identifier IDa of the client PC and an identifier IDb of the PC authentication device.

(3) The server registers a printer existing in an office where the PC authentication device having the identifier IDb is set as a printer which can be utilized by the client PC having the identifier IDa in such a manner that this printer can perform printing in response to an instruction of a program in the sever by using a function of an OS (Operating System) in the server.

Before the client PC coupled with the server performs print processing, the operation flow is executed to enable printing using the printer existing in a remote office.

It is to be noted that the PC authentication device is coupled with Internet in order to communicate with the server and hence the PC authentication device can also serve as a firewall which restricts access to an office from an external network such as Internet.

According to the present invention, printing can be performed by a regular print operation using a printer existing in the vicinity of the client PC without regard of a user. Furthermore, it is possible to avoid erroneous transmission to a printer provided in a different office.

As a result, a possibility of leak of information can be reduced.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 exemplifies a configuration of a system according to the present embodiment;

FIG. 2 exemplifies a configuration of a system according to the present embodiment;

FIG. 3 exemplifies an outline of a processing flow of the system according to the present embodiment;

FIG. 4 exemplifies a configuration of a server 100 according to the present embodiment;

FIG. 5 exemplifies a configuration-of a PC authentication device 102/302 according to the present embodiment;

FIG. 6 exemplifies a configuration of a client PC 300 according to the present embodiment;

FIG. 7 exemplifies a processing flow of network connection according to the present embodiment;

FIG. 8 exemplifies a processing flow of device authentication according to the present embodiment;

FIG. 9 exemplifies a processing flow of connected position notification processing according to the present embodiment;

FIG. 10 exemplifies a print management table according to the present embodiment;

FIG. 11 exemplifies a processing flow of print processing and connectable printer deletion processing according to the present embodiment; and

FIG. 12 exemplifies a device configuration of the client PC 300 and the PC authentication device 102/302.

### DETAILED DESCRIPTION OF THE EMBODIMENTS

An embodiment of the present invention will now be described hereinafter.

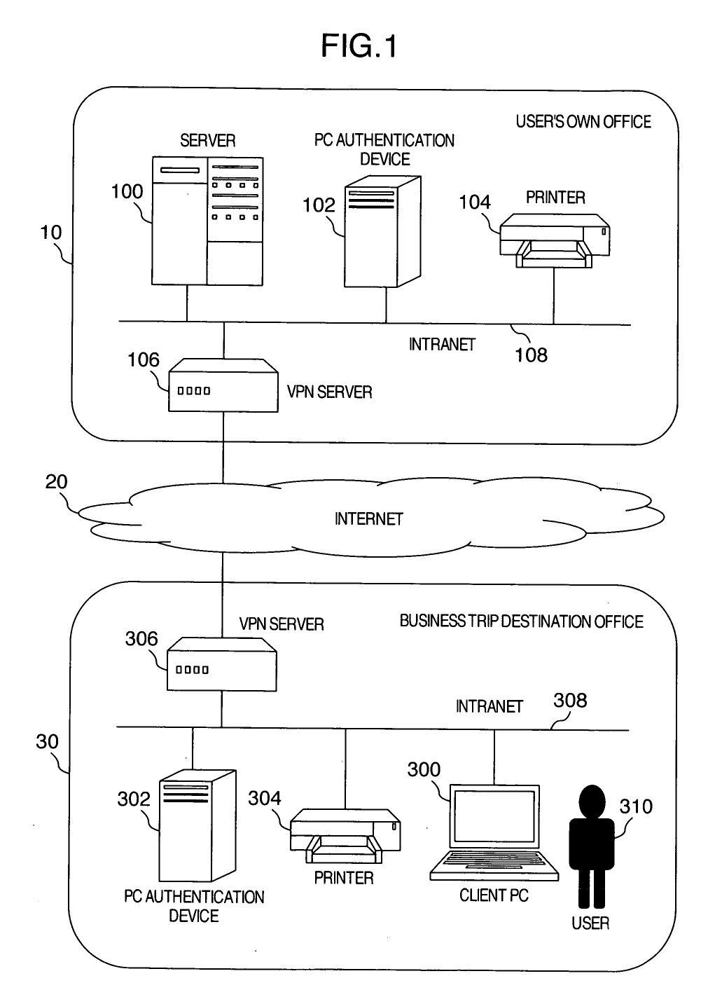

FIG. 1 is a block diagram of a system according to this embodiment. This system is constituted of its own office 10 where a server is set, Internet 20, and a business trip destination office 30. The office in this embodiment means an intranet surrounded by a firewall and a group of devices which can be coupled with this intranet. That is, since a private address alone is allocated to a device coupled with the intranet of the office, each device in the office cannot directly access the Internet 20. Moreover, a packet such as SMTP or HTTP from an external specific device is allowed to pass through the firewall by control of the firewall.

The business trip destination office 30 is coupled with the system's own office 10 through the Internet 20. It is to be noted that only one business trip destination office 30 exists in FIG. 1, but a plurality of business trip destination offices may be coupled with the system's own office 10.

The system's own office 10 is provided with a server 100 which uniformly manages resources such as application software or files, a PC authentication device 102 which performs device authentication with the client PC to recognize existence of the authenticated device, a printer 104, and a VPN server 106 which encrypts communication with the business trip destination office 30. These devices are all coupled with the intranet 108 in the system's own office 10 so that they can communicate with each other.

Incidentally, it is assumed that the server 100 respectively independently manages resources concerning the plurality of client PCs.

The business trip destination office 30 includes a PC authentication device 302, a printer 304 and a VPN server 306. These devices are all coupled with an intranet 308.

The PC authentication device 302 can communicate with the server 100 though the VPN servers 306 and 106. It is to be noted that the VPN servers 306 and 106 are provided to avoid wiretapping by a third party and they are not essential devices in this embodiment. For example, when the system's own office 10 is coupled with the business trip destination office 30 through a dedicated line, the VPN servers 106 and 306 are not required.

The embodiment shown in FIG. 1 is an example in which a user 310 has left on a business trip to the business trip destination office 30 while bringing the client PC 300 with him/her. The client PC 300 can establish a communication path between itself and the server 100 through the intranets 308 and 108 and the VPN servers 306 and 106. The user 310 can operate resources allocated to the client PC 300 in the server 100 through a display, a keyboard, a mouse and others of the client PC 300. Authentication and a communication method between the client PC 300 and the server 100 are equivalent to those in a regular thin client system, and screen information of an application (differential information of a screen before-and-after changing) is transferred to and displayed in the client PC 300 based on a known protocol for a thin client, e.g., an RDP (Remote Desktop Protocol) or ICA (Independent Computer Architecture) protocol. Moreover, operating information of an input device such as a mouse or a keyboard is transmitted from the client PC 300 to the server 100 based on the protocol.

In this embodiment, the client PC 300 can establish a communication path between itself and not only the server 100 but also the PC authentication device 302 through the intranet 308. It is to be noted that the intranet 308 may be of a wired type or a wireless type.

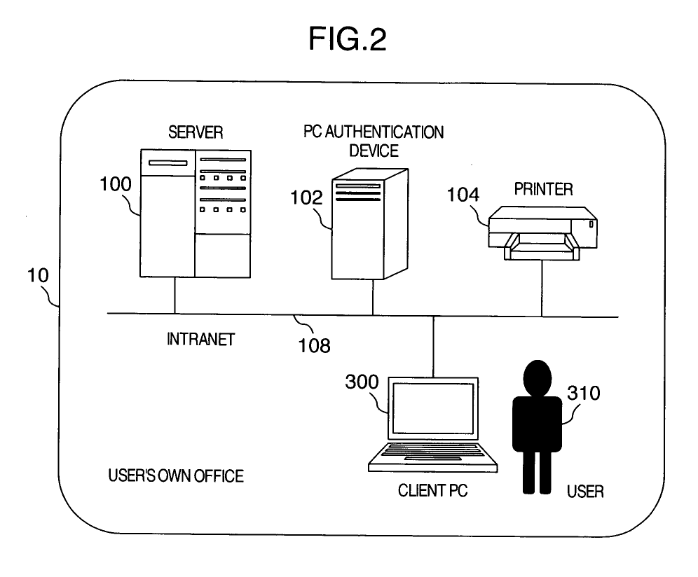

FIG. 1 exemplifies an example where the client PC 300 is coupled with the intranet 308 in the business trip destination office 30, but this embodiment similarly operates even in a case where the user 310 exists in his or her own office 10. FIG. 2 is a block diagram of the system in such a case. The client PC 300 can communicate with the server 100 and the PC authentication device 102 through the intranet 108. The intranet 108 may be of a wired type or a wireless type. This embodiment is characterized in that the an office provided with a printer used for printing includes the PC authentication device irrespective of office types such as a user's own office or a business trip destination office.

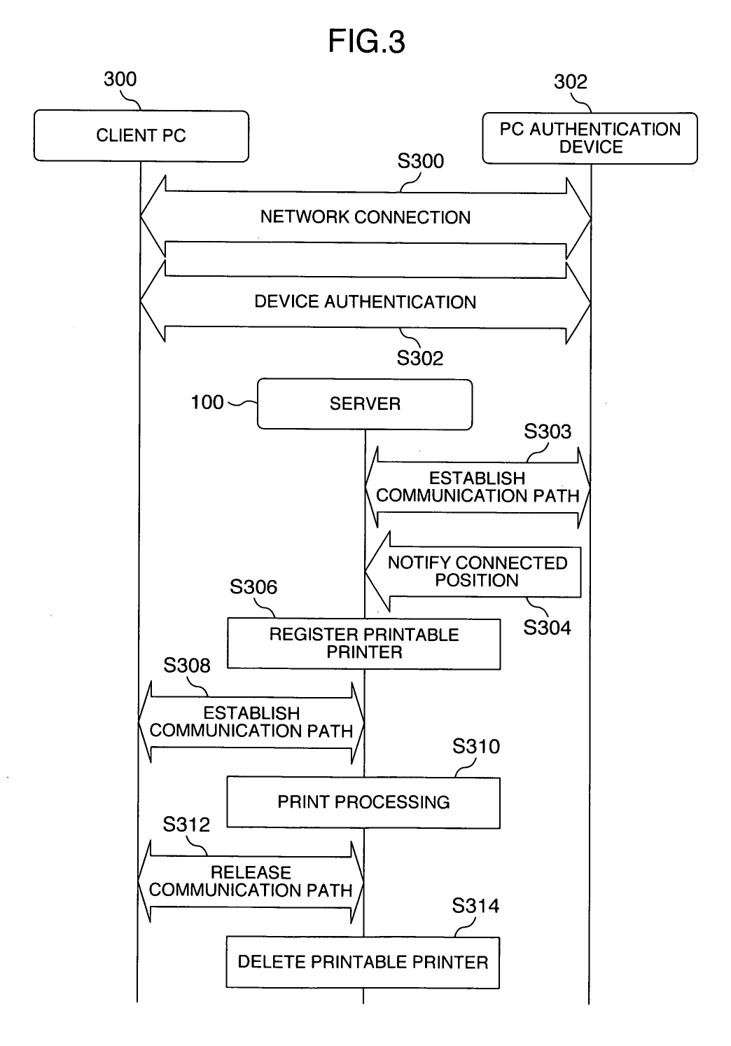

FIG. 3 is a schematic view showing a processing flow of the system according to this embodiment. Operations of the server 100, the client PC 300 and the PC authentication device 302 are as follows.

(S300) Communication path establishment processing is executed between the client PC 300 and the PC authentication device 302. A device which detects the PC authentication device is provided to the client PC 300, and a device which monitors new connection is provided to the PC authentication device 30. These devices are used to complete establishment of a communication path between the client PC 300 and the PC authentication device 302.

(S302) Device authentication is carried out between the client PC 300 and the PC authentication device 302. The client PC 300 and the PC authentication device 302 have their own certificates for device authentication, and these certificates are used to execute device authentication. The PC authentication device 302 acquires an identifier IDa of the client PC 300 based on device authentication, and the communication path between the client PC 300 and the PC authentication device 302 is released after acquisition.

(S303) The PC authentication device 302 establishes a communication path between itself and the server 100.

(S304) The PC authentication device 302 executes processing of notifying the server 100 of a place where the client PC 300 exists. Specifically, the PC authentication device 302 transmits the identifier IDa of the client PC 300 and the identifier IDb of the PC authentication device 302 to the server 100, and releases the communication path between the PC authentication device 302 and the server 100 after transmission.

(S306) The server 100 executes printable printer registration processing. Although printing is not allowed with respect to any user (i.e., the client PC) in the server 100 in a regular state, the server 100 registers the printer existing in the office where the PC authentication device having the identifier IDb is set as a printer which can be utilized by the client PC having the identifier IDa by this processing so that printing is enabled in response to an instruction of a program in the server by utilizing a function of an OS (Operating System) of the server.

(S308) The client PC 300 performs establishment processing of a communication path between itself and the server 100. After establishment of the communication path, the user 310 can modify data in the server 100 by using an application such as documentation or create a new document to be saved in the server 100. In a case where modified data is to be printed by using the printer existing in the business trip destination office 30, if the above-described processing is normally executed, one or more printers existing in the business trip destination office 30 are already selectable. If not, there is no printer which can be used.

(S310) The user 310 performs a regular print operation (as well as a printer selecting operation as required), and the server 100 starts print processing in response to an instruction from the user 310. A print execution job is transmitted to the printer 304.

(S312) The client PC 300 logs out, and requests the server 100 to terminate a session. Upon receiving the termination request, the server 100 releases the communication path between itself and the client PC 300.

(S314) The server 100 executes printable printer deletion processing. The printable printer registered at S306 is deleted.

Particulars of the processing flows S300 and S302 and particulars of the print control processing S304, S306, S308, S310, S312 and S314 will be described later.

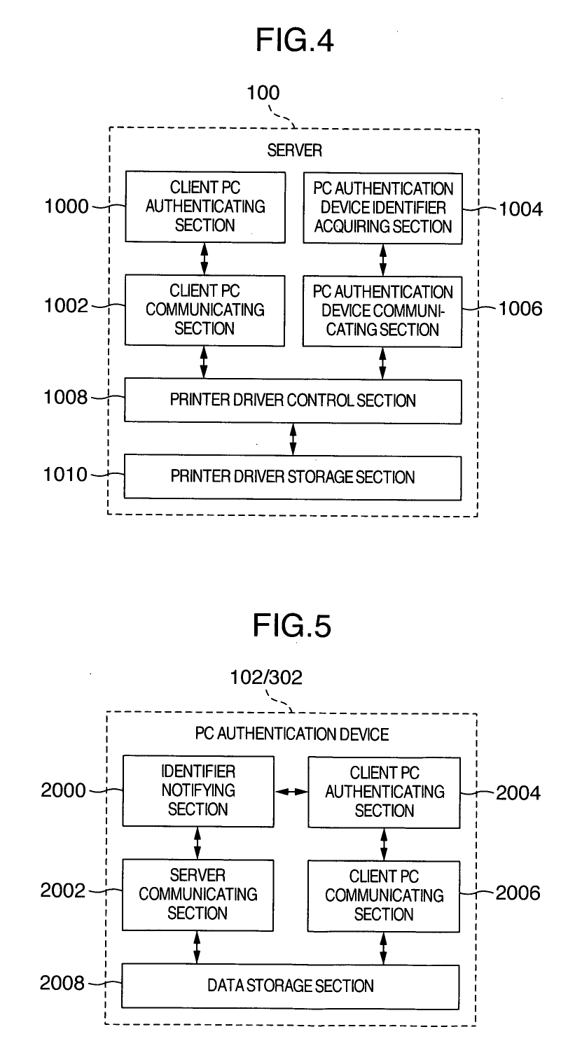

FIG. 4 is a function block diagram of the server 100. A client PC authenticating section 1000 performs authentication with the client PC 300. A client PC communicating section 1002 receives an operation of, e.g., a keyboard or a mouse from the client PC 300, and transmits screen data in which the received operation is reflected and should be displayed in a display of the client PC 300 to the client PC 300. A PC authentication device identifier acquiring section 1004 communicates with the PC authentication device 302 to acquire the identifier IDa of the client PC 300 and the identifier IDb of the PC authentication device 302. A PC authentication device communicating section 1006 is in charge of communication with the PC authentication device 302. A printer driver control section 1008 registers or deletes a printer driver which can be utilized by the user of the client PC 300 based on the identifier IDa of the client PC 300 and the identifier IDb of the PC authentication device 302 supplied thereto.

FIG. 5 is a function block diagram of the PC authentication device 102/302. An identifier notifying section 2000 notifies the server 100 of identifiers of the client PC 300 and the PC authentication device 102/302 through a server communicating section 2002. The server communicating section 2002 is in charge of communication with the server 100. A client PC authenticating section 2004 performs authentication with the client PC 300 to acquire an identifier, and supplies the acquired identifier of the client PC 300 to the identifier notifying section 2000. A client PC communicating section 2006 transmits/receives data with respect to the client PC 300. A data storage section 2008 has authenticating information and others required for authentication with the server 100 or the client PC 300.

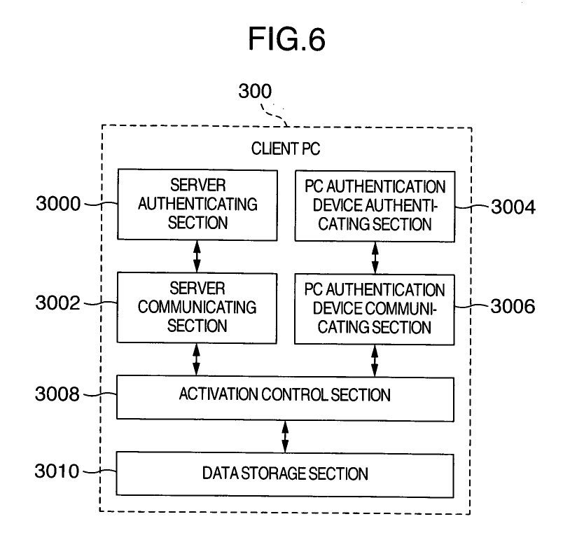

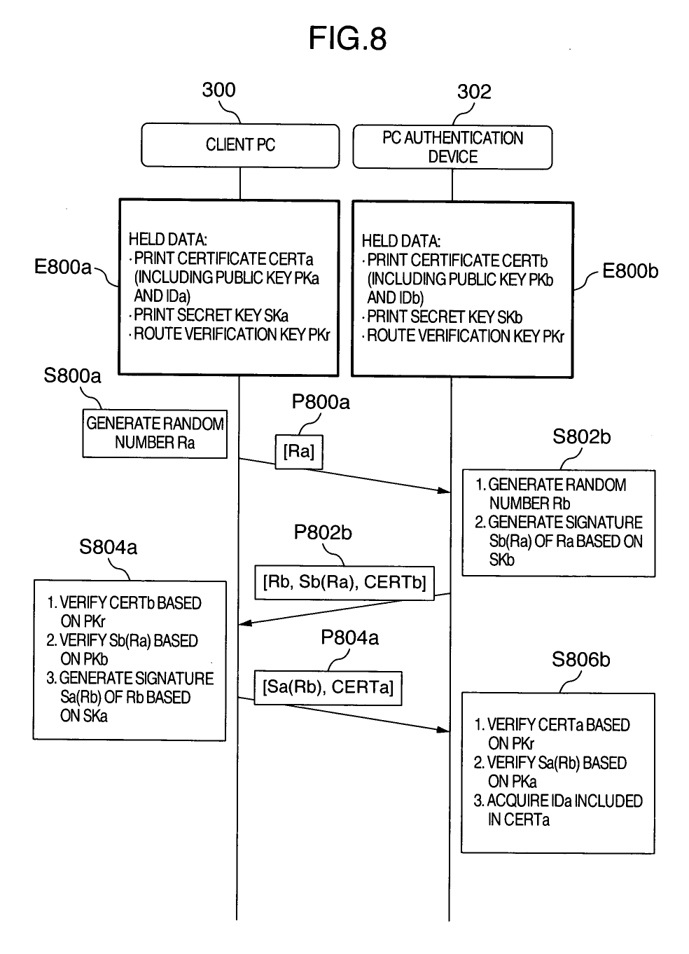

FIG. 6 is a function block diagram of the client PC 300. A server authenticating section 3000 performs authentication with the server 100. A server communicating section 3002 transmits/receives data with respect to the server 100. A PC authentication device authenticating section 3004 carries out authentication with the PC authentication device 302 through a PC authentication device communicating section 3006. An activation control section 3008 controls activation of the above-described devices. An example in which the activation control device 3008 activates the other devices at the time of start-up of the client PC 300 will be described later. A data storage section 3010 stores authenticating information and others required for authentication with the server 100 or the PC authentication device 302. The authenticating information consists of a certificate which is released to a third party and a secret key which is not released. The certificate consists of a public key which forms a pair with the secret key and identifying information of a device. Particulars of authentication will be described later with reference to FIG. 8.

A hardware configuration of the server 100, the authentication device 102/302 and the client 300 will be described later with reference to FIG. 12.

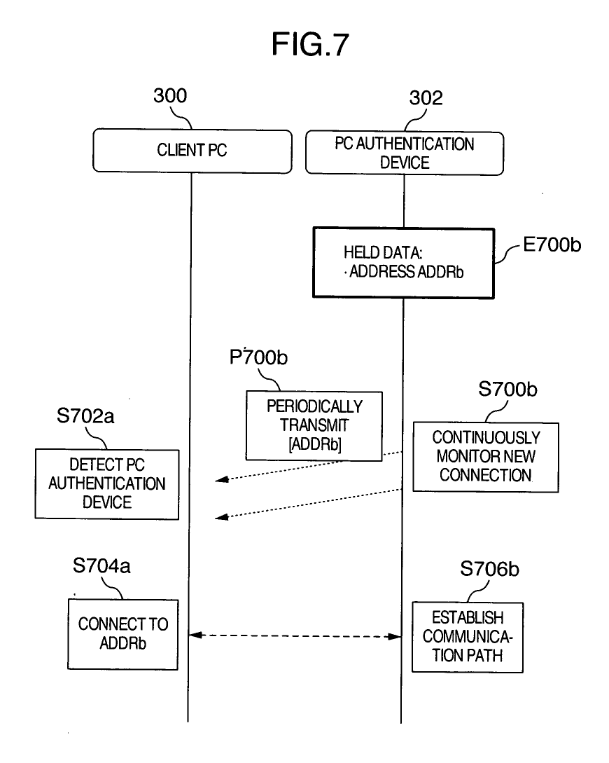

A description will now be given as to an embodying mode of the communication path establishment processing S300 and the device authentication processing S302 in this embodiment with reference to FIGS. 7 and 8.

FIG. 7 is a processing flow of the communication path establishment processing S300. For this processing, the PC authentication device 302 holds an network address ADDRb of the intranet 308 to which the PC authentication device 302 belongs as held data E700b in the data storage section 2008. The client PC 300 and the PC authentication device 302 use the held data E700b to establish a communication path in accordance with the following processing procedure.

(S700b) The PC authentication device 302 repeatedly (e.g., periodically at predetermined time intervals) performs broadcast transmission of a packet P700b including the address ADDRb of its own device as data to a wireless LAN or the intranet 308 of the business trip destination office 30 through the client PC communicating section 2006, and continuously waits for new connection.

(S702a) The client PC 300 acquires an address in the intranet 308 issued by a non-illustrated DHCP server or the like and couples with the intranet 308. After connection, it receives the packet P700b repeatedly transmitted from the PC authentication device 302 at the time of activation, thereby acquiring the address ADDRb of the PC authentication device 302. It is to be noted that the packet P700b is received by not only activation but also starting up an application which attempts reception of the packet P700b through the PC authentication device communicating section 3006. Alternatively, the client PC 300 may repeatedly (e.g., periodically at predetermined time intervals) attempt reception of P700b. In any case, the above-described processing is controlled by the PC authentication device communicating section 3006.

(S704a) (S706b) The client PC 300 attempts connection to the address ADDRb acquired through the PC authenticating device communicating section 3006 to establish a communication path with itself and the PC authentication device 302. When the communication path cannot be established even though a given fixed time has elapsed, a fact that the communication path cannot be established between the client PC 300 and the PC authentication device is displayed in a display E1000 (see FIG. 12) of the client PC 300. In this case, the user 310 can re-execute the processing from S702a by activating the application which attempts the reception. When the communication path cannot be established without re-execution, the processing of this embodiment is terminated. In this case, since a printer which can be used by the server cannot be registered, printing is impossible from the client PC 300.

FIG. 8 shows a processing flow of the device authentication processing S302.

For this processing, the client PC 300 holds in an authenticating information storage section 3010 a print certificate CERTa (including a public key PKa and an identifier IDa), a print secret key SKa corresponding to the public key PKa and a root verification key PKr which is used to verify a certificate as held data E800a. The certificate CERTa is issued by a reliable certificate authority managed by, e.g., a manger who manages the system's own office 10, the business trip destination office 30 or the like or a reliable third-party organization (which are referred to as a root). The certificate CERTa is a certificate which is used to appropriately perform printing in a printer provided in the same office where the client PC 300 exists from the server 100, and hence it is called a print certificate.

Likewise, the PC authentication device 302 holds in a certificate storage section 2008 a print certificate CERTb (including a public key PKb and an identifier IDb), a print secret key SKb corresponding to the public key PKb and a root verification key PKr as held data E800b. After establishing network connection, the client PC 300 and the PC authentication device 302 use the held data E800a and E800b to execute device authentication in accordance with the following procedure.

(S800a) The client PC 300 generates a random number Ra in the PC authentication device authenticating section 3004, and transmits data P800a including Ra to the PC authentication device 302 through the PC authentication device communicating section 3006.

(S802b) The PC authentication device 302 generates a random number Rb in the client PC authenticating section 2004, and encrypts the received random number Ra by using the print secret key SKb to generate a signature SKb(Ra). Data P802b including the random number Rb, the signature SKb(Ra) and the print certificate CERTb is transmitted to the client PC 300 through the client PC communicating section 2006.

(S804a) The client PC 300 first uses the root verification key PKr to verify the acquired print certificate CERTb. That is, the signature of the print certificate CERTb generated by the root with the secret key is decrypted, and whether the encrypted signature matches with a hash value of CERTb is confirmed. If verification has succeeded, the public key PKb is then taken out from the certificate CERTb, and whether PKb(SKb(Ra)) obtained by encrypting the signature SKb(Ra) with PKb matches with Ra is verified.

If all of verification processing has succeeded, the client PC 300 uses the print secret key SKa to generate a signature SKa(Rb) of the received random number Rb, and transmits data P804b including the signature SKa(Rb) and the print certificate CERTa to the PC authentication device 302 through the PC authentication device communicating section 3006. If any of the above-described verifications has failed, the PC authentication device 302 determines that the server is not the proper authentication server, and terminates the device authentication processing. The verification is executed by the PC authentication device authenticating section 3004.

(S806b) The PC authentication device 302 first uses the root verification key PKr to verify the acquired print certificate CERTa. If this verification has succeeded, the public key PKa is then taken out from the certificate CERTa, and whether PKa(SKa(Rb)) obtained by decrypting the signature SKa(Rb) with PKa matches with Rb is verified. If they match with each other, the identifier IDa of the client PC 300 is finally acquired from the certificate CERTa, and the acquired identifier is stored in the data storage section 2008, thereby terminating the device authentication processing. If any of these verifications has failed, the PC authentication device 302 determines that the client PC 300 is not the proper client PC and terminates the processing. The verification processing is executed in the client PC authenticating section 2004.

The PC authentication device 302 can acquire the identifier IDa of the client PC 300 by using the network connection processing S300 and the device authentication processing S302. If network connection or device authentication has failed, a printer which can be used by the server cannot be registered, and hence printing from the client PC 300 is impossible.

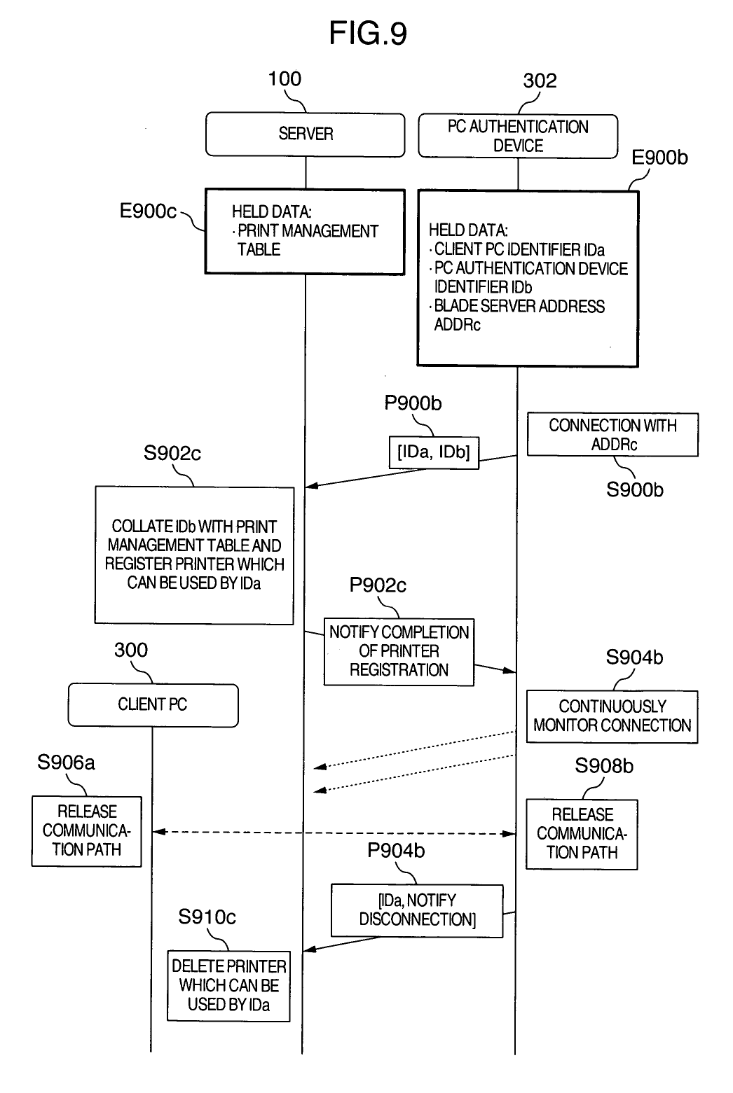

A description will now be given as to detailed embodying modes of the connected position notification processing S304, the connectable printer registration processing S306, the network connection processing S308, the print processing S310, the network connection/disconnection processing S312 and the connectable printer deletion processing S314 in this embodiment with reference to FIGS. 9, 10 and 11.

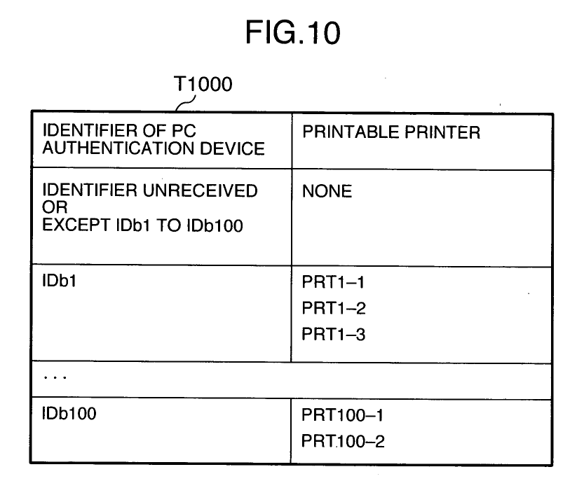

FIG. 9 shows a processing flow of the connected position notification processing S304. For this processing, the server 100 holds a print management table T1000 as held data E900c. The print management table will be described later in detail with reference to FIG. 10. The PC authentication device 302 holds the identifier IDa of the client PC 300 acquired in the device authentication processing S302, the identifier IDb of the PC authentication device 302 and the network address ADDRc of the server 100 as held data E900b. The server 100 and the PC authentication device 302 use the held data E900c and E900b to execute the connected position notification processing S304 and the connectable printer registration processing S306 in accordance with the following procedure.

(S900b) The PC authentication device 302 couples to the address ADDRc of the server 100 to establish a communication path between itself and the server 100 (S303 in FIG. 3). It is to be noted that this communication is performed on the assumption that the communication path encrypted through the VPN servers 106 and 306 has been established (see FIG. 1). After establishment of the communication path, data P900b including the identifier IDa of the client PC 300 and the identifier IDb of the PC authentication device is transmitted to the server 100.

(S902c) The server 100 collates the received identifier IDb with the print management table T1000, and registers a printer provided in the office where the PC authentication device having the identifier IDb is set as a printer which can be used by the client PC having the identifier IDa. The print management table and the printer registration method will be described later.

It is to be noted that the server 100 respectively independently manages resources concerning the plurality of client PCs, and registers printers in accordance with respective users based on the identifiers IDa and IDb. Therefore, usable printers differ depending on respective users. Further, in a case where printers have been already registered, the printers are all deleted in order to avoid printing using any printer when the identifiers IDa and IDb are not notified from the PC authentication device. After registration of a printer, the server 100 supplies a printer registration completed notification P902c to the PC authentication device 302.

The connectable printer registration processing S306 is completed in the processing S900b and S902c. If the client PC 300 continuously couples with the server 100 to start print processing, a flow of the next network connection processing S308 and subsequent processing is started.

Incidentally, there is a case where the communication path coupled with the server 100 is wirelessly established and the user 310 moves to a difference office with the client PC 300 while maintaining the communication path coupled with the server 100 after authentication and registration of a connectable printer. In this case, deletion and re-registration of the connectable printer are required in order to notify the server 100 of a fact that the user has moved to the different office. This is realized by the following processing.

(S904b) The PC authentication device 302 starts monitoring the communication path between itself and the client PC 300.

(S906a) The communication path between the client PC 300 and the PC authentication device 302 is released because, e.g., the user 310 has turned off a power supply of the client PC 300 or moved to another office.

(S908b) The PC authentication device 302 detects that the communication path between itself and the client PC 300 has been released. After detection, the server 100 is notified of the identifier IDa of the client PC 300 and information P904b indicating that the communication path between the PC authentication device 302 and this PC has been released.

(S910c) The server 100 receives the information P904b, and deletes a printer which can be used by the client PC 300 having the identifier IDa.

The client PC 300 performs device authentication with another PC authentication device 302 at the different office to which the user has moved in order to perform re-registration after deletion of the printer. In regard to this, as described in conjunction with the processing S702a in Embodiment 2, there is a method of storing in the client PC 300 an application which receives repeated transmission P700b from the PC authentication device 302 and effecting activation in response to an instruction from the user 310, or a method of providing a device which attempts reception of P700b in the activation control section 3008 (see FIG. 6).

T1000 in FIG. 10 shows an example of the print management table. A left-hand column shows identifiers of the PC authentication devices, and a right-hand column shows a list of printers provided in an office associated with each PC authentication device. For example, when IDa1 as an identifier of the client PC and IDb1 as an identifier of the PC authentication device are received, the client PC having the identifier IDa1 can perform printing with one of printers PRT1-1, PRT1-2 and PRT1-3. On the other hand, when an identifier of the client PC or the PC authentication device cannot be received, or when a received identifier of the PC authentication device is an identifier which is not listed in the print management table T1000 except IDb1 to IDb100, a printer is not registered. As a result, whether printing is enabled/disabled can be controlled in accordance with a destination of the client PC. It is to be noted that maintenance of T1000 may be carried out by a manager who manages the system's own office 10 or the business trip destination office 30.

Furthermore, a printable printer may be set in accordance with an identifier of each client PC. As a result, whether printing is enabled/disabled can be controlled while considering not only a destination of the client PC but also authority of a user.

A first method of registering a connectable printer based on the print management table T1000 is a method of installing a printer driver every time registration is performed and uninstalling the printer driver every time registration is canceled. In the example where the identifier of the client PC matches with IDa1 and the identifier of the PC authentication device matches with IDb1, the server 100 installs printer drivers of the printers PRT1-1, PRT1-2 and PRT1-3 as connectable printer registration processing.

A second method is a method of allowing system residence of a program which monitors a print API calling from the application (which will be referred to as a print management program hereinafter) and switching an enabled state and a disabled state of the print API based on the print management table T1000 to control whether a printer can be used.

Like the above description, in the example where the identifier of the client PC matches with IDa1 and the identifier of the PC authentication device matches with IDb1, the print management program monitors the print API calling by the application to distinguish a print target printer. The program enables the print API only when the printer is PRT1-1, PRT1-2 or PRT1-3, and disables the print API in case of printing using a different printer to avoid printing. According to this method, the print management program must be prepared for system residence, but an operation can be performed at a higher speed than the first method. Particulars concerning the print management program are described in, e.g., U.S. Patent Application Publication No. 2002/0099837.

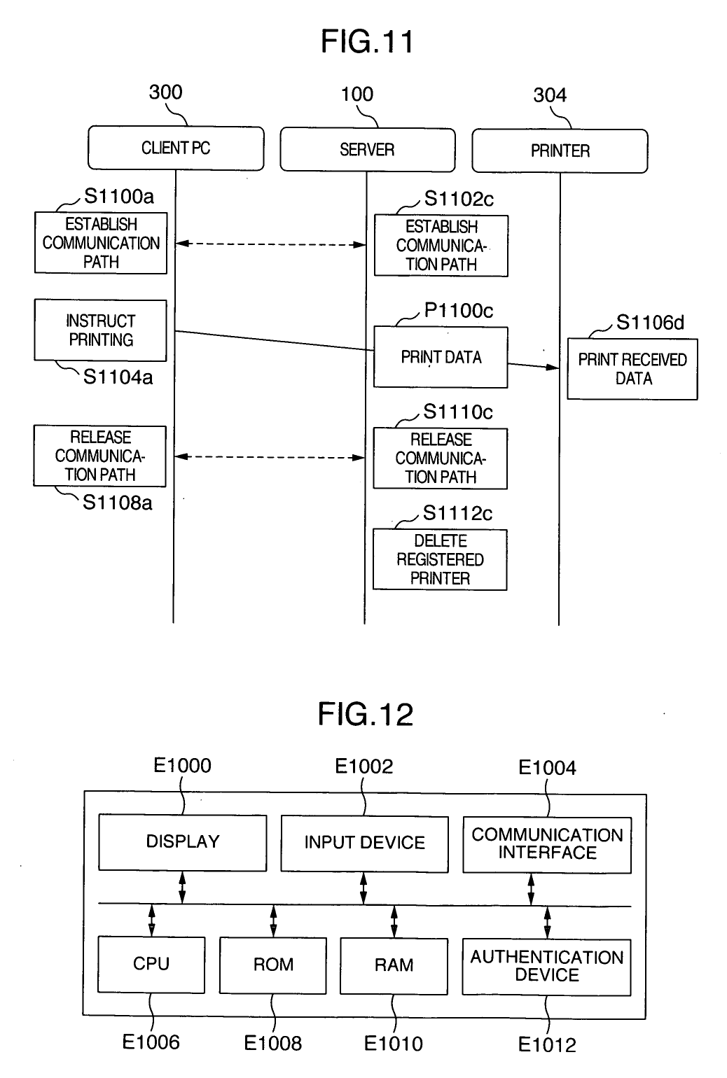

FIG. 11 shows a processing flow of the network connection processing S308, the print processing S310, the network connection/disconnection processing S312 and the connectable printer deletion processing S314. The client PC 300, the server 100 and the printer 304 execute the processing in accordance with the following procedure.

(S1100a) The client PC 300 establishes a communication path between itself and the server 100. An establishment method is equivalent to that of the regular thin client system.

(S1102c) The server 100 establishes a communication path between itself and the client PC 300. After establishment, a user of the client PC 300 can operate resources of the server 100 through a keyboard, a mouse or a display of the client PC 300. If the above-described connectable printer registration processing S902 has been normally terminated, the client PC 300 can already perform printing using the printer 304 in the business trip destination office 30 where the user currently exists. If a plurality of printers are provided in the office 30, the plurality of printers are selectable. If the connectable printer registration processing S308 has failed or the processing have already failed on a previous stage of the processing S308, a connectable printer is not registered, and hence printing cannot be performed by using the printer 304.

(S1104a) The user 310 operates the client PC 300 to instruct the server 100 to perform printing. Upon receiving the print instruction, the server 100 creates print data P1100c and transmits it to the printer 304.

(S1106d) The printer 340 receives the print data P1100c and starts printing.

(S1108a) (S1110c) The client PC 300 releases the communication path between itself and the server 100.

(S1112c) The server 100 deletes the connectable printer registered in the connectable printer registration processing S902 after releasing the communication path. Specifically, when the method of installing printer drivers is adopted, all the installed drivers are uninstalled. When the method of switching to a printable user is adopted, the user is switched to an original user.

According to the methods of the foregoing embodiment, the server 100 can recognize an office where the client PC 300 currently exists, thereby preventing data in the server 100 from erroneously being printed by using a printer provided in a different office.

Additionally, according to this embodiment, the PC authentication device 302 is set in each office, and the PC authentication device 302 notifies the server 100 of the identifier of the client PC 300 and an identifier of the office (i.e., the identifier of the PC authentication device 302). Therefore, there is an effect that the server 100 can recognize an office where the client PC 300 exists.

FIG. 12 shows an example of a hardware configuration of the client PC 300, the server 100 and the PC authentication device 102/302. These devices can be realized by a general computer having the configuration shown in FIG. 12.

Specifically, each device includes a display E1000, an input device E1002 such as a keyboard or a mouse, a communication interface E1004, a CPU E1006, a non-volatile memory (which is called an ROM) E1008, a volatile memory (which is called an RAM) E1010, and an authentication device E1012. The user 310 can use the input device E1002 to issue an instruction while confirming an operation result in the display E1000. A certificate required for authentication is stored in the authentication device E1012, and has tamper resisting properties so that the certificate can be accessed by a predetermined method only. A program having a device required for processing of the client PC 300 and the PC authentication device 102/302 or an equivalent function is stored in the ROM E1008, and executed by the CPU E1006. Temporary data required for processing is stored in the RAM E1010. Data stored in the RAM E1010 is lost when a power supply is turned off.

Each function (each processing section) of each device shown in FIG. 4, 5 or 6 is implemented by the computer when the CPU E1006 executes the program stored in the ROM E1008. Each program may be stored in the ROM E1008 in advance. Alternatively, the ROM E1008 may be formed of a writable non-volatile memory, and the program may be installed in the ROM E1008 from another device through a medium which can be used by the computer as required. The medium means, e.g., a detachable storage medium or a communication medium (i.e., a network, or a carrier wave or a digital signal propagated through the network).

It is to be noted that the server 100 shown in FIG. 4 corresponds to the plurality of client PCs 300 in the above description. However, there may be the plurality of servers 100 each corresponding to one user (one client PC) in one computer depicted in FIG. 12. Further, in a structure where a plurality of blade type servers provided with the configuration shown in FIG. 12 are accommodated in one rack, one server 100 may be configured in one blade server.

In this embodiment, it is good enough for the client PC 300 to be provided with the function of remotely operating the server 100 and performing device authentication with the PC authentication device 102/302. It is also good enough for the PC authentication device 102/302 to be able to effect device authentication with the client PC 300 and communicate with the server 100. Therefore, both PCs do not require an external storage medium. Like this embodiment, eliminating an unnecessary external storage medium from the client PC 300 and the PC authentication device can prevent leaks of data due to missing or theft.

The specification and drawings are, accordingly, to be regarded in an illustrative rather than a restrictive sense. It will, however, be evident that various modifications and changes may be made thereto without departing from the spirit and scope of the invention as set forth in the claims.

1. A print system in which a communication path is established between a client device coupled with a first network and a server device coupled with a second network and a user operates the client device to print information stored in the server device,
wherein one or more printers and an authentication device which can establish a communication path between itself and the server device are coupled to the first network,
the server device manages the printer coupled with the first network in association with identifying information of the authentication device,
the authentication device transmits identifying information IDb of the authentication device to the server device, and
the server device performs:
receiving the identifying information IDb from the authentication device;
registering a printer associated with the identifying information IDb of the authentication device as a printer configured to print and output by an operation of the client device; and
establishing a communication path between itself and the client device.

2. The print system according to claim 1, wherein each of the client device and the authentication device attempts device authentication, and
the authentication device acquires identifying information IDa of the client device and transmits it to the server device when the device authentication has succeeded.

3. The print system according to claim 2, wherein, when a printer configured to print and output by an operation of the client device identified by the identifying information IDa has been already registered at the time of receiving the identifying information IDa and IDb from the authentication device, or when the client device releases the communication path established between itself and the server deice, the server device deletes the registered printer.

4. The print system according to claim 1, wherein the server device notifies the authentication device of registration completion of the printer,
the authentication device performs:
monitoring the communication path between itself and the client device when notification of registration completion of the printer is received; and
notifying the server device of releasing of the communication path when the communication path is released, and
the server device deletes the registered printer of the client device when it is notified of releasing of the communication path between the authentication device and the client device from the authentication device.

5. The print system according to claim 1, wherein the authentication device repeatedly transmits a network address of the authentication device to the first network, and
the client device is coupled with the first network to receive the network address, and establishes a communication path between itself and the authentication device.

6. The print system according to claim 5, wherein the client device has a certificate CERTa including a public key PKa and the identifying information IDa, a secret key SKa corresponding to the public key PKa, and a root verification key PKr corresponding to the certificate CERTa,
the authentication device has a certificate CERTb including a public key PKb and the identifying information IDb, a secret key SKb corresponding to the public key PKb, and a root verification key PKr corresponding to the certificate CERTb, and
in the device authentication,
the client device generates a random number Ra and transmits it to the authentication device through the communication path between itself and the server device,
the authentication device generates a random number Rb and transmits the random number Rb, SKb(Ra) obtained by encrypting the random number Ra with the secret key SKb and the certificate CERTb to the client device through the communication path between itself and the client device,
the client device performs:
verification of the certificate CERTb by using the root verification key PKr;
decryption of the SKb(Ra) by using the public key PKb to verify whether a result of the decryption matches with the random number Ra; and
transmission of SKa(Rb) obtained by encrypting the random number Rb with the secret key SKa and the certificate CERTa to the authentication device through the communication path between itself and the authentication device when the verification has succeeded, and
the authentication device verifies the certificate CERTa by using the root verification key PKr, decrypts SKa(Rb) by using the public key PKa to verify whether a result of the decryption matches with the random number Rb, and acquires the identifying information IDa included in the certificate CERTa when the verification has succeeded.

7. The print system according to claim 5, wherein the client device performs:
repeatedly receiving a network address of the authentication device; and
starting establishment of the communication path between itself an the authentication device when the network address is received.

8. The print system according to claim 3, wherein the server device performs:
installing a driver of a printer associated with the authentication device identified by the identifying information IDb in registration processing of the printer; and
uninstalling the driver in deletion processing of the printer.

9. The print system according to claim 2, wherein the server device performs:
managing the printer coupled with the first network in association with the identifying information of the client device and the identifying formation of the authentication device;
receiving the identifying information IDa and IDb from the authentication device; and
registering the printer associated with the identifying information IDa of the client device and the identifying information IDb of the authentication device as a printer configured to print and output by an operation of the client device including the identifying information IDa.

10. The print system according to claim 7, wherein the server device includes authority of allowing the printer coupled with the first network to which the authentication device belongs to print data,
the authority is given for processing of registering the printer, and
the authority is eliminated for processing of deleting the registered printer.
